(19) United States
(12) Patent Application Publication
(10) Pub. No.: US 2007/0111681 A1
(43) Pub. Date: May 17, 2007

(54) Transmit power allocation in wireless communication devices

(76) Inventors: William P. Alberth JR., Crystal Lake, IL (US); William E. Welnick, Poway, CA (US)

Correspondence Address: MOTOROLA INC, 600 NORTH US HIGHWAY 45, ROOM AS437, LIBERTYVILLE, IL, 60048-5343, US

(21) Appl. No.: 11/273,231

(22) Filed: Nov. 14, 2005

(51) Int. Cl. H04B 1/04; H04B 1/02; H01Q 11/12

(52) U.S. Cl. 455/127.1; 455/103

(57) ABSTRACT

A portable multimode wireless communication device (100) including first and second transmitters (110, 120) coupled to corresponding antennas or to a common antenna. The portable device controls (130) an output power of one or both of the first and second transmitters so that a characteristic, for example, the combined specific absorption rate, of the transmitters of the portable multimode wireless communication device does not exceed a specified limit.

### FIELD OF THE DISCLOSURE

The present disclosure relates generally to wireless communications, and more particularly to power management in wireless mobile communication devices, for example, in CDMA/GSM multi-mode cellular handsets.

### BACKGROUND OF THE DISCLOSURE

Multi-mode cellular communication devices commonly include multiple transceivers, for example, in CDMA and GSM transceivers that operate simultaneously. These multi-mode devices may also include a WIFI and/or a Bluetooth (BT) transceiver. In wireless communication devices, power management and specific absorption rate (SAR) regulation compliance are ever present challenges, particularly in view of the trend toward multi-mode devices and the increasing requirement of wireless communication network operators for transceivers having higher output power capabilities.

The various aspects, features and advantages of the instant disclosure will become more fully apparent to those having ordinary skill in the art upon careful consideration of the following Detailed Description with the accompanying drawings described below. The drawings may have been simplified for clarity and are not necessarily drawn to scale.

### BRIEF DESCRIPTION OF THE DRAWINGS

FIG. 1 illustrates a wireless communication device having multiple transceivers.

FIG. 2 illustrates a wireless communication device controller.

FIG. 3 illustrates a process flow chart.

### DETAILED DESCRIPTION

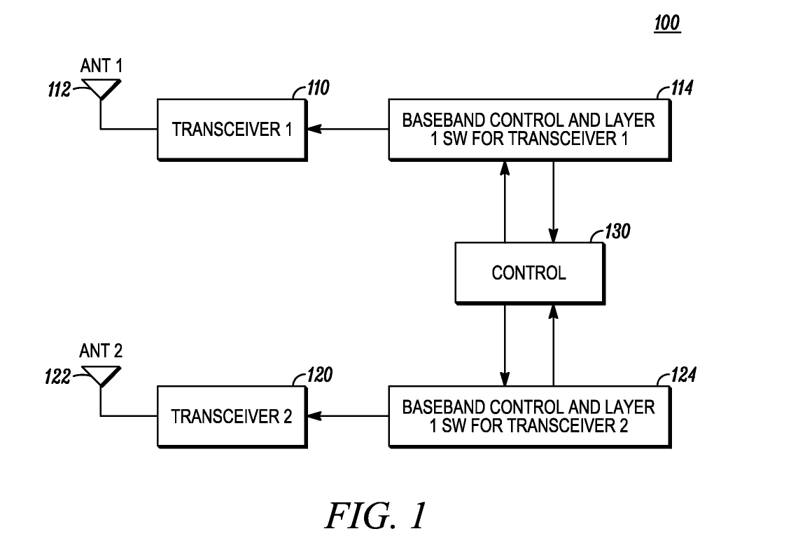

FIG. 1 illustrates a portable wireless communication device 100. Such devices may be embodied as a multi-mode cellular communications handset, for example, a Global System for Mobile Communications (GSM)/Universal Mobile Telecommunications System (UMTS) compliant handset. In other embodiments, the multi-mode communication device may include a WLAN and/or a WAN transceiver with one or more cellular transceivers. The multi-mode wireless communication device is not intended to be limited by any of the exemplary types of transmitters or transceivers disclosed herein. The particular transmitter type and/or the particular protocol with which the transmitter complies are not particularly relevant.

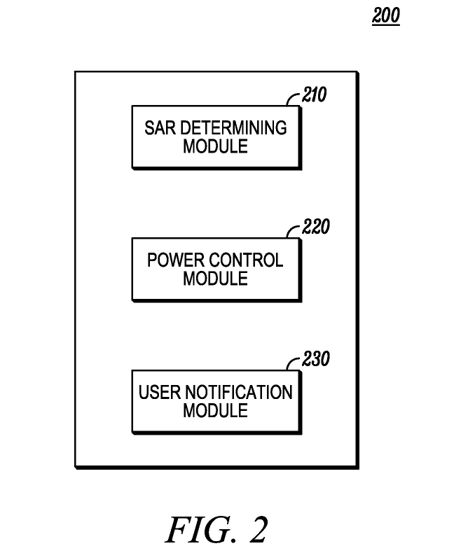

In FIG. 1, the portable wireless communication device 100 comprises generally a first transmitter 110 coupled to a first antenna 112 and a second transmitter 120 coupled to a second antenna 122. While the first and second transmitters in FIG. 1 are coupled to corresponding antennas, in other embodiments the two or more transmitters may share a common antenna. In FIG. 1, the first and second transmitters are embodied as first and second transceivers. The first transceiver is associated with a baseband controller 114, which may include layer 1 software. The second transceiver is associated with a baseband controller 124, which may also include layer 1 software. In alternative embodiments, the baseband controllers 114 and 124, shown separately in FIG. 2, are implemented as a single entity, for example, a digital signal processor (DSP).

Some portable wireless communication devices, for example, cellular communication handsets, may also include a user interface including a display, a keypad and other inputs and outputs. Such devices also typically include a rechargeable or replaceable battery with a limited energy supply. These and other well known elements and features of portable wireless communication devices are known generally by those having ordinary skill in the art and are not discussed further herein.

In FIG. 1, the multimode wireless communication device also includes a controller 130 capable of controlling the output power of the first and second transmitters. More generally, in embodiments where there are multiple transceivers, the controller generally controls the output power of the other transmitters. The controller may be implemented as part of one or more processors, for example, a common DSP, or it may be a separate control entity. Multi-mode wireless communication device architectures are known generally and thus the implementation details thereof are not discussed in further detail herein. The output power control functionality, discussed more fully below, may be implemented in a processor or in some other control entity of known wireless communication device architectures. The control functionality is readily implemented by a programmably controlled digital processor using software stored in memory.

The specific absorption rate (SAR) is a measure of the amount of radio frequency energy absorbed by a body when using a wireless transmitter. The SAR may be expressed in units of watts per kilogram (W/kg). In some industries the SAR specification or limit associated with a particular transmitter is established by a provincial entity or by a standards setting body. The SAR associated with each transmitter is generally a function of several variables including but not limited to the transmit output power, antenna design and location, shielding associated with the transmitter housing structure, transmit signal frequency and modulation format, among other factors. The determination of the specific absorption rate associated with a particular wireless communication device is known generally by those having ordinary skill in the art.

For a multi-mode device having multiple transmitters, the total specific absorption rate, SAR_{TOTAL,} may be expressed as a summation:
SAR_{TOTAL}=F(x₁, x₂, x₃ . . . )+G(y₁, y₂, y₃ . . . )+ . . . (1)

Generally the SAR is presented by a corresponding function for each transmitter antenna combination. In equation (1), each function, F, G . . . in the summation corresponds to a unique transmitter antenna combination and the corresponding variables are represented by xₓ and yₓ. The summation of functions F and G in equation (1) characterizes the total SAR for a multi-mode device having two transmitters. A time averaged SAR may be obtained by integrating the summation over a specified time interval.

The output power of one or more wireless transmitters is generally controlled, for example, limited by a controller. In some applications, the control of the output power of the one or more transmitters may by performed to comply with, or to operate the wireless communication device within, a specific absorption rate (SAR) specification. In other applications, the transmitter output power is controlled to optimize the SAR of the device relative to a specified SAR. The transmitter output power may also be controlled to limit battery power consumption of the wireless communication device. The transmitter output power may also be controlled for other reasons, including combinations of the examples discussed above. These and other aspects of the disclosure are discussed more fully below.

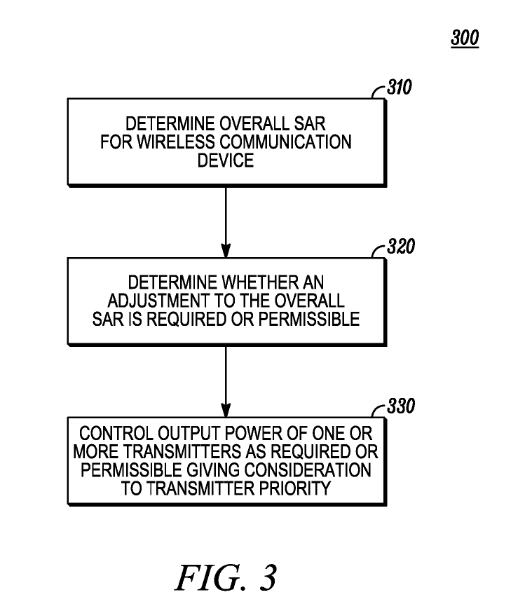

In the process diagram 300 of FIG. 3, at 310, the controller determines an overall SAR for the wireless communication device. In devices having multiple transmitters, the total SAR is determined by summing the SAR for each transmitter. The determination of the SAR may be made using equation 1 above or by other means known by those having ordinary skill in the art. In another embodiment, the controller determines a time averaged SAR for the one or more transmitters of the device. In some applications, for example, the time period over which the SAR is averaged is specified by a standards organization or by a governmental regulatory body. Time averaging the SAR may also be suitable for applications where two or more transmitters operate virtually simultaneously, for example, in an interleaved transmit mode.

In one embodiment illustrated in FIG. 2, the controller 200 includes a specific absorption rate (SAR) determining module 210 that is configured to determine a specific absorption rate associated with one or more transmitters of the device. As noted above, the SAR determination is based in part on the output power of the corresponding transmitters. In FIG. 1, the controller 130 obtains the variable information transmit information that may be necessary for the SAR determination from the baseband control layer entities 114 and 124. The variable information includes but is not limited to transmit power level, frequency and/or modulation format etc. The SAR may be determined by the controller using equation (1) above. Alternatively, the SAR for each transmitter may be determined using a look-up table stored in memory of the device. The look-up table values for different power levels, frequencies, etc. may be obtained using equation 1. In one embodiment, the look-up table includes multiple values, which are selected based on a particular transmitter power level and/or other variable information upon which the SAR is determined for the particular transmitter. As noted, this variable information may be obtained by the controller from the transmitters. The SAR values determined for multiple transmitters are then combined by summing the individual transmitter SAR determinations.

In FIG. 2, the controller includes a power control module 220 for controlling the output power of the one or more transmitters based on the SAR determination. In one embodiment, the controller provides a signal for controlling the output power of the one or more transmitters. In FIG. 1, the controller 130 provides the control signal to the baseband controller entities 114 and 124, which in turn provide a control signal to the transmitters. As suggested above, the controller may provide the control signal to a single baseband controller entity rather than the discrete entities illustrated in FIG. 1. Alternatively, the controller could provide the control signal directly to the transmitters. The disclosure is not intended to be limited to any particular control architecture since the particular mechanism by which transmitter power is controlled depends generally on the architecture of the wireless communication device.

In FIG. 3, at 320, the controller determines whether an adjustment to the overall SAR of the portable wireless communication device is required or permissible, for example, based on a specified SAR limit or some other criteria. In one embodiment, the SAR for one or more transmitters is compared to a reference SAR, and then the power of the one or more transmitters is adjusted based on the comparison. The computed SAR that is compared to the reference may be an instantaneous SAR or a time averaged SAR. For the case where the computed SAR is an instantaneous SAR, it is compared to an instantaneous reference SAR. Similarly, for the case where the computed SAR is a time averaged SAR, the time averaged SAR it is compared to a time averaged reference SAR.

In FIG. 3, at 330, the controller controls the output power of one or more transmitters as required or permissible. Consideration may also be given to communication priorities associated with the transmitters as discussed further below. In one embodiment, the power control module reduces the output power of one or more transmitters to reduce the overall SAR, for example, within a specified limit. In another embodiment, the power control module increases the power output of one or more transmitters to optimize the communication link, without exceeding a specified SAR limit. In other embodiments, the power control module adjusts the output power of one or more transmitters to control or optimize battery power consumption.

In some embodiments, the controller prioritizes certain communications, for example, when it is necessary to reduce the output power of the one or more transmitters. In cellular communication applications, for example, a voice call may be carried by the first transmitter and a non-voice call may be carried by another transmitter. If the voice call has priority, the output power of the other transmitter carrying the non-voice call may be reduced to limit the specific absorption rate of the portable wireless communication device. Alternatively, if it is possible to increase the output power of one of the transmitters without exceeding a specified limit, the transmitter carrying the voice call may be increased if the voice call has the higher priority.

In another cellular communication application, a data call may be carried by the first transmitter and another communication channel may be carried by the other transmitter. If the data call has priority, the output power of the transmitter carrying the data call may be reduced to limit a specific absorption rate of the portable wireless communication device. Alternatively, if an increase in the output power is available without exceeding a SAR limit or a power drain limit, the output power of the transmitter carrying the data call may be increased if the data call has a higher prioritization than the other communication channel carried by the other transmitter.

In another cellular communication application, an overhead communication call may be carried by the first transmitter and another communication channel may be carried by the second transmitter. If the overhead communication call has priority, the output power of the second transmitter carrying the other communication channel may be reduced to limit a specific absorption rate of the portable wireless communication device. Alternatively, if an increase in the output power is available without exceeding a SAR limit, the transmitter carrying the overhead communication call may be increased if the overhead communication call has a higher prioritization than the other communication channel.

In FIG. 2, in some embodiments, the controller includes a notification module 230 for notifying a user of a change in communication associated with one of the first and second transmitters due to a change in the output power of at least one of the transmitters. A change in the communication associated with a particular transmitter may result from a reduction in the output power. For example, if the overall SAR of a portable wireless communication device in concurrent voice and data calls must be reduced, preservation of the voice call quality may require reduction in the output power of the transmitter associated with the data call. If the transmit power associated with the data call is reduced to a level where the performance of the data call may affected, the notification module may notify the user that the signal level is weak.

Communication equipment is typically licensed for specific operation which may include a limit on the permissible radiated energy. Those skilled in the art will recognize that the methods presented here could be applied to maintain regulatory compliance to maximum radiated emissions of equipment containing multiple transceivers.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a portable wireless communication device having first and second transmitters, the method comprising:
operating the first and second transmitters;
adjusting an output power of at least one of the first and second transmitters to limit a total amount of power emitted by the portable wireless communication device.

2. The method of claim 1,
determining a specific absorption rate associated with the first transmitter, determining a specific absorption rate associated with the second transmitter,
adjusting the output power includes adjusting the output power of at least one of the first and second transmitters so that a combined specific absorption rate of the first and second transmitters does not exceed a specified limit.

3. The method of claim 1, operating the first and second transmitters simultaneously.

4. The method of claim 2,
operating the first and second transmitters virtually simultaneously,
adjusting the output power includes adjusting the output power of at least one of the first and second transmitters so that a specific absorption rate of the first and second transmitters does not exceed a specified limit.

5. The method of claim 1, carrying a voice call with the first transmitter and carrying a non-voice call with the second transmitter, adjusting the output power includes controlling the output power of the second transmitter within a specific absorption rate limit of the portable wireless communication device.

6. The method of claim 1, carrying a data call with the first transmitter and carrying a communication channel with the second transmitter, adjusting the output power includes controlling the output power of the second transmitter to within a specific absorption rate limit of the portable wireless communication device.

7. The method of claim 1, carrying a higher priority communications call with the first transmitter and carrying a lower priority communication channel with the second transmitter, adjusting the output power includes controlling the output power of the second transmitter to within a specific absorption rate limit of the portable wireless communication device.

8. A portable multimode wireless communication device, comprising:
a first transmitter coupled to an antenna;
a second transmitter coupled to an antenna,
the portable multimode wireless communication device controlling an output power of at least one of the first and second transmitters so that a characteristic of the transmitter of the portable multimode wireless communication device does not exceed a specified limit.

9. The device of claim 8, where the transmitter characteristic is specific absorption.

10. The device of claim 9,
a controller communicable coupled to the first and second transmitters,
the controller providing a signal for controlling the output power of at least one of the first and second transmitters so that a combined specific absorption rate of the portable multimode wireless communication device does not exceed the specified limit.

11. The device of claim 9,
the controller determining a specific absorption rate associated with the first transmitter and a specific absorption rate associated with the second transmitter,
the controller adjusting the output power of at least one of the first and second transmitters so that a combined specific absorption rate of the first and second transmitters does not exceed a specified limit.

12. The device of claim 9,
the first and second transmitters configured to operate virtually simultaneously,
the controller providing a signal for controlling the output power of at least one of the first and second transmitters so that a time averaged specific absorption rate of the first and second transmitters does not exceed the specified limit.

13. The device of claim 9,
the first transmitter configured for a first communication channel at a first power level, the second transmitter configured for a second communication channel,
the controller configured to reduce an output power of the second transmitter so that a combined specific absorption rate of the first and second transmitters does not exceed the specified limit.

14. The method of claim 1,
the first transmitter configured for a data call and the second transmitter configured for a communication channel,
the controller configured to reduce an output power of the second transmitter so that a combined specific absorption rate of the first and second transmitters does not exceed the specified limit.

15. The method of claim 1,
the first transmitter configured for a higher priority communications call and the second transmitter configured for a lower priority communication channel,
the controller configured to reduce an output power of the second transmitter so that a combined specific absorption rate of the first and second transmitters does not exceed the specified limit.

16. A portable multimode wireless communication device, comprising:
a first transmitter coupled to a first antenna;
a second transmitter coupled to a second antenna,
a controller communicably coupled to the first and second transmitter,
the controller including a power control module for controlling an output power of at least one of the first and second transmitters so that a combined specific absorption rate of the first and second transmitters does not exceed a specified limit.

17. The method of claim 16, the power control module for controlling the output power of at least one of the first and second transmitters so that a combined time averaged specific absorption rate of the first and second transmitters does not exceed a specified limit.

18. The method of claim 16, the first transmitter configured for a first transmit channel, the power control module adjusts a maximum output of the second transmitter such that a combined specific absorption rate of the first and second transmitters does not exceed a specified limit.

19. The method of claim 16, the controller including a notification module for notifying a user of a change in communication associated with one of the first and second transmitters due to a change in the output power of at least one of the first and second transmitters.
